(19) United States
(12) Patent Application Publication
(10) Pub. No.: US 2022/0198118 A1
(43) Pub. Date: Jun. 23, 2022

(54) APPARATUS AND METHOD FOR MANUFACTURING A MOTHERBOARD COMPRISING ONE OR MORE ELECTROCHROMIC DEVICES

(71) Applicant: SAGE ELECTROCHROMICS, INC., Faribault, MN (US)

(72) Inventors: Glenn GENGEL, Red Wing, MN (US); Dallas AKRE, Lonsdale, MN (US); Steve PALM, Minneapolis, MN (US); Brian RUEHLE, St. Louis Park, MN (US)

(21) Appl. No.: 17/644,953

(22) Filed: Dec. 17, 2021

Related U.S. Application Data
(60) Provisional application No. 63/128,257, filed on Dec. 21, 2020.

(51) Int. Cl. G06F 30/392; G06F 30/398; G02F 1/153

(52) U.S. Cl. CPC G06F 30/392; G02F 1/153; G06F 30/398

(57) ABSTRACT

An apparatus and method of manufacturing a motherboard is disclosed. The motherboard can include one or more electrochromic devices. The apparatus can include a central processing unit that executes instructions. The instructions and method can include mapping the motherboard, analyzing one or more electrochromic devices within a batch to determine a yield of each of the one or more electrochromic devices, prioritizing the one or more electrochromic devices based on the yield, and placing a first electrochromic device on the motherboard, where the first electrochromic device has the highest priority of the one or more electrochromic devices within the batch.

### CROSS-REFERENCE TO RELATED APPLICATION(S)

This application claims priority under 35 U.S.C. § 119(e) to U.S. Provisional Application No. 63/128,257, entitled “AN APPARATUS AND METHOD FOR MANUFACTURING A MOTHERBOARD COMPRISING ONE OR MORE ELECTROCHROMIC DEVICES,” by Glenn GENGEL et al., filed Dec. 21, 2020, which is assigned to the current assignee hereof and incorporated herein by reference in its entirety.

### FIELD OF THE DISCLOSURE

The present disclosure is related to electrochemical devices and method of forming the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. The optical modulation is the result of the simultaneous insertion and extraction of electrons and charge compensating ions in the electrochemical material lattice. Advances in electrochromic devices seek the devices have faster and more homogeneous switching speeds while maintaining through-put during manufacturing.

As such, further improvements are sought in manufacturing electrochromic devices.

### BRIEF DESCRIPTION OF THE DRAWINGS

FIG. 1 is a schematic cross-section of an electrochromic device, according to one embodiment.

FIG. 2 is a flow chart depicting a process for manufacturing a motherboard with one or more electrochemical devices, in accordance with an embodiment of the current disclosure.

FIGS. 3A-3D are schematic top views of one or more electrochromic devices on a motherboard at various stages of manufacturing, in accordance with an embodiment of the present disclosure.

FIG. 4 is a schematic illustration of a top view of one or more electrochromic devices on a motherboard, according to another embodiment of the current disclosure.

FIG. 5 is a schematic illustration of an insulated glazing unit, according the embodiment of the current disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated.

Patterned features, which include bus bars, holes, holes, etc., can have a width, a depth or a thickness, and a length, wherein the length is greater than the width and the depth or thickness. As used in this specification, a diameter is a width for a circle, and a minor axis is a width for an ellipse.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

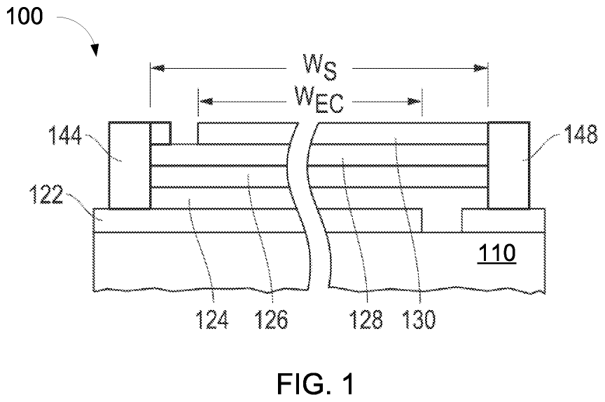

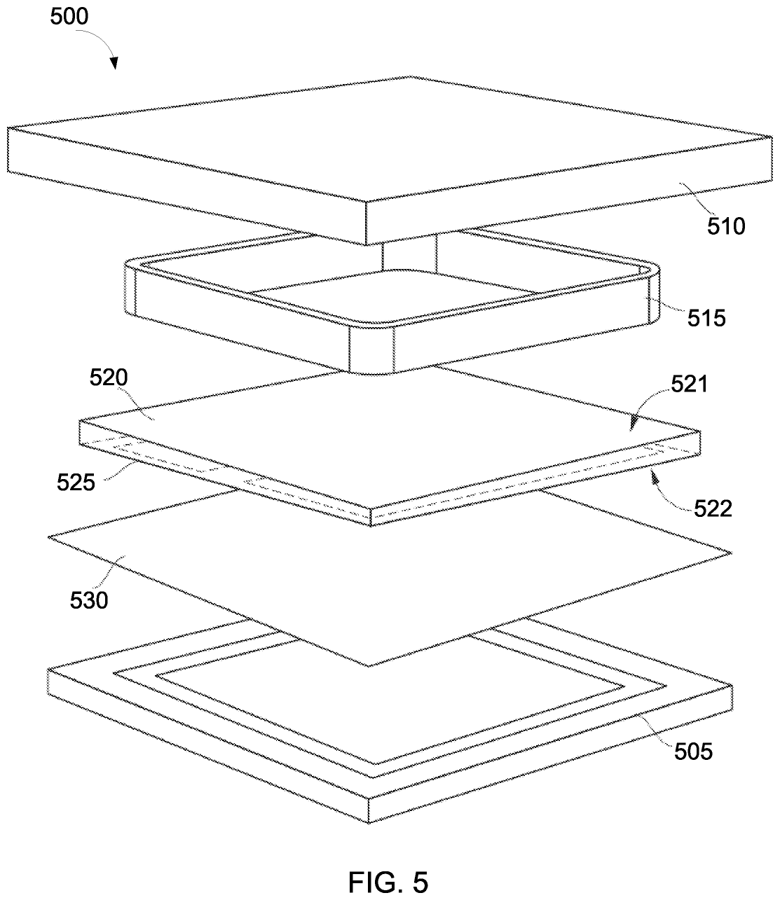

In accordance with the present disclosure, FIG. 1 illustrates a cross-section view of a partially fabricated electrochemical device 100 having an improved film structure. For purposes of illustrative clarity, the electrochemical device 100 is a variable transmission device. In one embodiment, the electrochemical device 100 can be an electrochromic device. In another embodiment, the electrochemical device 100 can be a thin-film battery. In another embodiment, the electrochemical device 100 can be a laminate device with a substrate and active stack. In yet another embodiment, the electrochromic device 100 can be an insulated glazing unit, such as the IGU described below with respect to FIG. 5.

However, it will be recognized that the present disclosure is similarly applicable to other types of scribed electroactive devices, electrochemical devices, as well as other electrochromic devices with different stacks or film structures (e.g., additional layers) and liquid crystal devices, dichroic dies, light emitting diode devices, organic light emitting diode devices. With regard to the electrochemical device 100 of FIG. 1, the device 100 may include a substrate 110 and a stack overlying the substrate 110. The stack may include a first transparent conductor layer 122, a cathodic electrochemical layer 124, an anodic electrochemical layer 128, and a second transparent conductor layer 130. In one embodiment, the stack may also include an ion conducting layer 126 between the cathodic electrochemical layer 124 and the anodic electrochemical layer 128.

In an embodiment, the substrate 110 can include a glass substrate, a sapphire substrate, an aluminum oxynitride substrate, or a spinel substrate. In another embodiment, the substrate 110 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 110 may or may not be flexible. In a particular embodiment, the substrate 110 can be float glass or a borosilicate glass and have a thickness in a range of 0.5 mm to 12 mm thick. The substrate 110 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 110 can include ultra-thin glass that is a mineral glass having a thickness in a range of 50 microns to 300 microns. In a particular embodiment, the substrate 110 may be used for many different electrochemical devices being formed and may referred to as a motherboard.

Transparent conductive layers 122 and 130 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 122 and 130 can include gold, silver, copper, nickel, aluminum, or any combination thereof. The transparent conductive layers 122 and 130 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 122 and 130 can have a thickness between 10 nm and 600 nm. In one embodiment, the transparent conductive layers 122 and 130 can have a thickness between 200 nm and 500 nm. In one embodiment, the transparent conductive layers 122 and 130 can have a thickness between 320 nm and 460 nm. In one embodiment the first transparent conductive layer 122 can have a thickness between 10 nm and 600 nm. In one embodiment, the second transparent conductive layer 130 can have a thickness between 80 nm and 600 nm.

The layers 124 and 128 can be electrode layers, wherein one of the layers may be a cathodic electrochemical layer, and the other of the layers may be an anodic electrochromic layer (also referred to as a counter electrode layer). In one embodiment, the cathodic electrochemical layer 124 is an electrochromic layer. The cathodic electrochemical layer 124 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 124 can have a thickness between 100 nm to 400 nm. In one embodiment, the cathodic electrochemical layer 124 can have a thickness between 350 nm to 390 nm. The cathodic electrochemical layer 124 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 128 can include any of the materials listed with respect to the cathodic electrochromic layer 124 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 128 can have a thickness between 150 nm to 300 nm. In one embodiment, the anodic electrochromic layer 128 can have a thickness between 250 nm to 290 nm. In some embodiments, lithium may be inserted into at least one of the first electrode 130 or second electrode 140.

In another embodiment, the device 100 may include a plurality of layers between the substrate 110 and the first transparent conductive layer 122. In one embodiment, an antireflection layer can be between the substrate 110 and the first transparent conductive layer 122. The antireflection layer can include SiO₂, NbO₂, Nb₂O₅ and can be a thickness between 20 nm to 100 nm. The device 100 may include at least two bus bars with one bus bar 144 electrically connected to the first transparent conductive layer 122 and the second bus bar 148 electrically connected to the second transparent conductive layer 130.

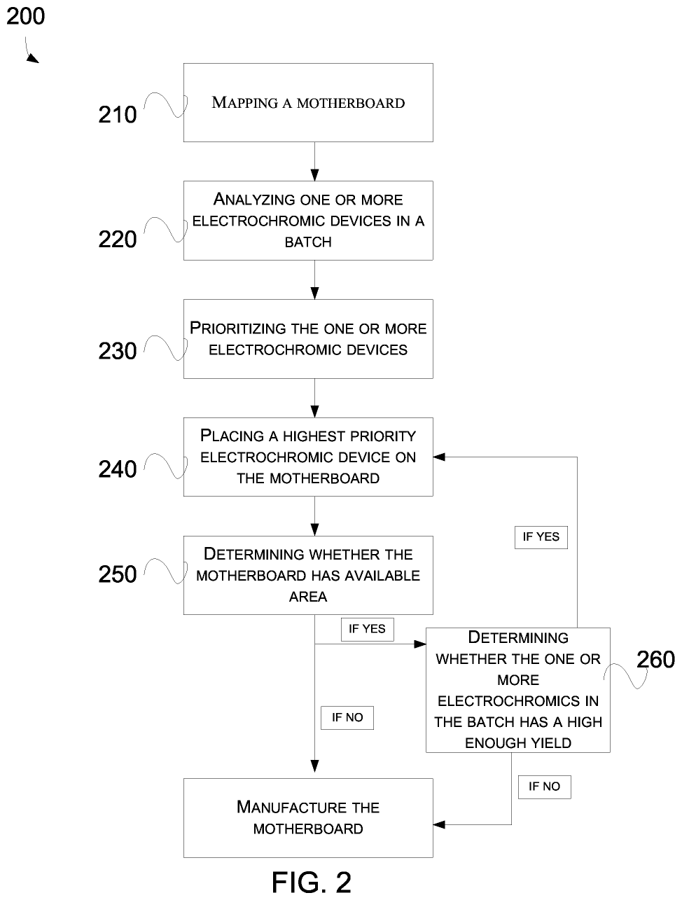

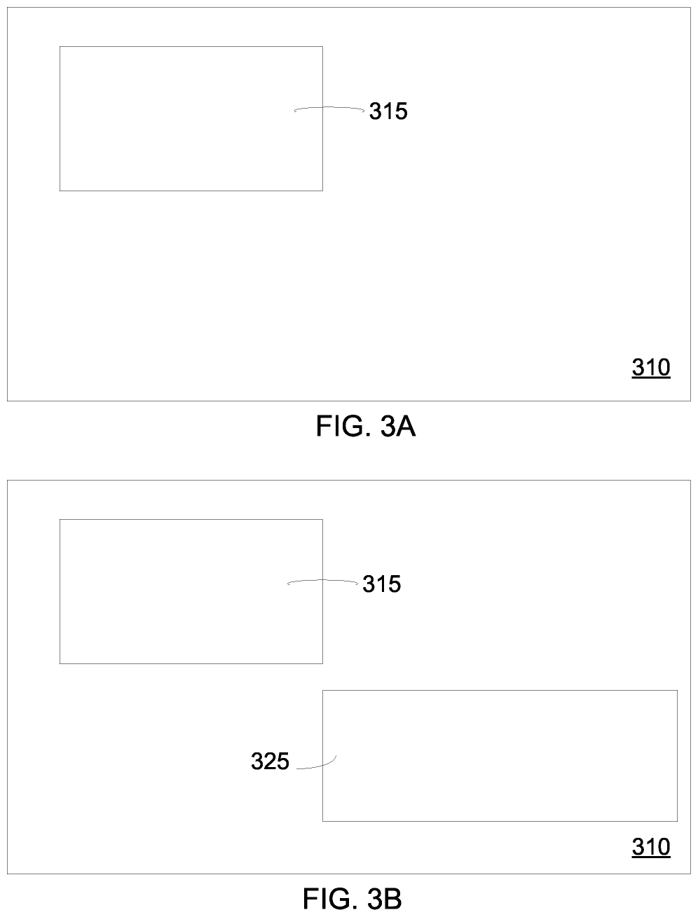

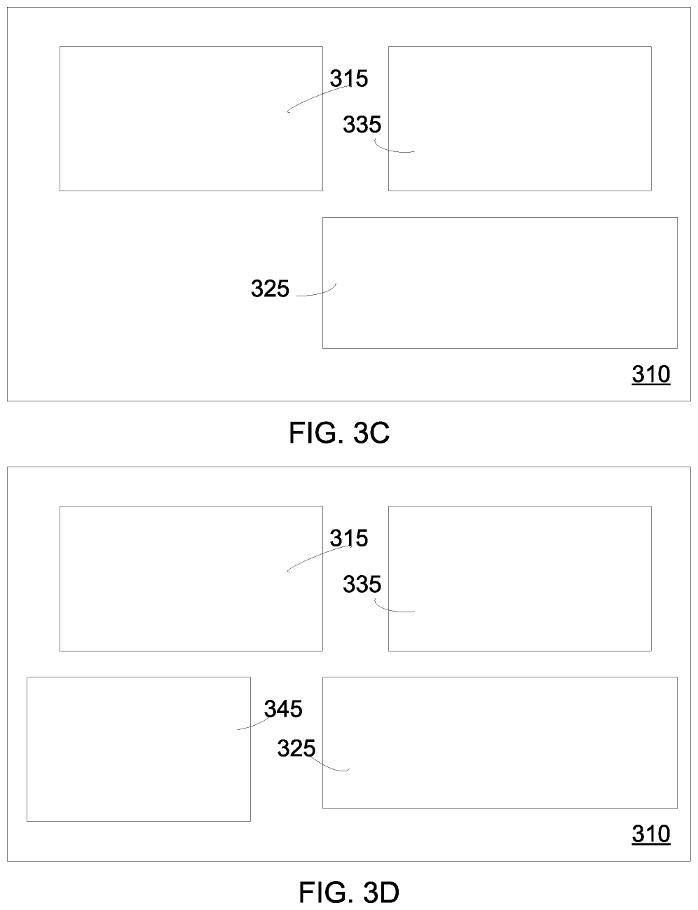

FIG. 2 is a flow chart depicting a process 200 for placing one or more electrochromic devices on a motherboard in accordance with an embodiment of the current disclosure. FIGS. 3A-3D are schematic top views of one or more electrochromic devices on a motherboard 310 at various stages of manufacturing in accordance with an embodiment of the present disclosure. The one or more electrochromic devices electrochromic devices 300 can be the same as the electrochromic device 100 described above.

The process can include providing a motherboard 310. The motherboard 310 can be similar to the substrate 110 described above. At operation 210, a motherboard can be mapped. In one embodiment, mapping the motherboard can include determining the available space on the motherboard. In another embodiment, mapping the motherboard can include determining the available surface area of the motherboard not occupied by an electrochromic device.

At operation 220, one or more electrochromic devices can be analyzed to determine the characteristics of each of the one or more electrochromic devices. Analyzing the one or more electrochromic devices can include gathering information about the number of electrochromic devices in a batch and the characteristics of each of the one or more electrochromic devices. In one embodiment, analyzing each of the one or more electrochromic devices can include predicting the yield of each of the one or more electrochromic devices. In one embodiment, predicting the yield of each of the one or more electrochromic devices can include determining the height to width aspect ratio, determining the scribe orientation, determining the geometric yield, determining the materials used for instance whether the one or more electrochromic devices is a triple glass unit or double glass unit, determining the distance between the bus bars on the one or more electrochromic devices, determining the scribe location, determining the resistance of each of the one or more electrochromic devices, and determining the voltage output necessary to transition the one or more electrochromic devices from a clear state to a tint state.

At operation 230, the one or more electrochromic devices are prioritized. In one embodiment, prioritization is based on the yield of each of the one or more electrochromic devices within the batch versus the cost to manufacture each of the one or more electrochromic devices. In one embodiment, the characteristics of each of the one or more electrochromic devices is cross-referenced with the map of the motherboard. In one embodiment, each electrochromic device is placed in order of highest yield to least yield. In another embodiment, each of the one or more electrochromic devices are place in order of least costly to highest costly. In one embodiment, each of the one or more electrochromic devices are placed based on a combination of highest yield and lowest cost to lowest yield and highest cost. In one embodiment, the one or more electrochromic devices are prioritized using historical production data.

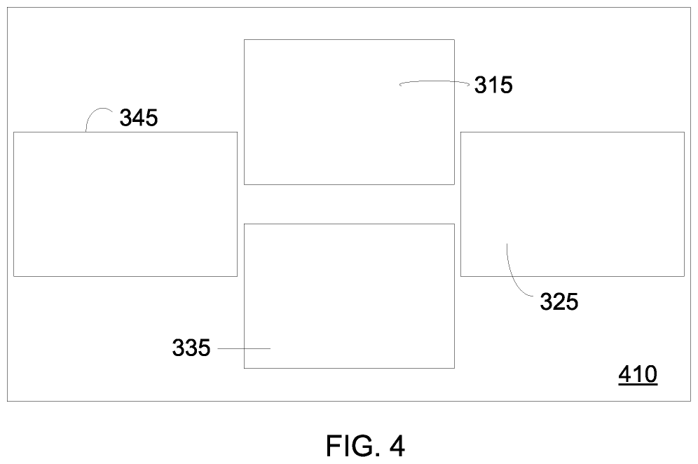

At operation 240, a first electrochromic device 315 is placed on the motherboard 310, as seen in FIG. 3A. In one embodiment, the first electrochromic device 315 has the highest priority as determined by operation 230. In one embodiment, the first electrochromic device 315 is the highest yielding device within the batch. In another embodiment, the first electrochromic device 315 is the lowest costing within the batch. In another embodiment, the first electrochromic device 315 is the most difficult to manufacture within the batch. Once an electrochromic device has been placed on the motherboard, it is removed from the batch. For example, once the first electrochromic device 315 is placed on the motherboard 310, the first electrochromic device 315 is removed from the batch so that the first electrochromic device 315 is not selected again. In one embodiment, the first electrochromic device 315 is placed adjacent a corner of the motherboard 310. In another embodiment, as seen in FIG. 4, the first electrochromic device 315 is placed about the center of a side of the motherboard 410.

At operation 250, the motherboard 310 is analyzed to determine whether the motherboard 310 still has available area. If the motherboard has available space then the batch is analyzed to determine whether there are any other electrochromic devices with a high enough yield to be placed on the motherboard 310, at operation 260. In one embodiment, determining if any of the one or more electrochromic devices within the batch has a high enough yield includes determining whether the yield of any of the one or more electrochromic devices within the batch is within between 1% and 30% of the yield of the last electrochromic device placed on the motherboard. In one embodiment, determining if any of the one or more electrochromic devices within the batch has a high enough yield includes determining whether the yield of any of the one or more electrochromic devices within the batch is within between 2% and 20% of the yield of the last electrochromic device placed on the motherboard. In one embodiment, determining if any of the one or more electrochromic devices within the batch has a high enough yield includes determining whether the yield of any of the one or more electrochromic devices within the batch is within between 5% and 10% of the yield of the last electrochromic device placed on the motherboard. If yes, as seen in FIG. 3B, the process continues by going back to operation 240 and placing the highest priority electrochromic device still within the batch on the motherboard 310 and then determining whether the motherboard has available area at operation 250. In one embodiment, one or more electrochromic devices may be added to the batch. In such an embodiment, after determining whether the motherboard has available area at operation 250, the process may continue by going back to operation 220 and continuing forward from there. For example, in one embodiment, the process begins again at operation 220 by analyzing the one or more electrochromic devices still within the batch, continuing to operation 230 by prioritizing the one or more electrochromic devices within the batch, continuing to operation 240 by placing the highest priority electrochromic device still within the batch on the motherboard 310, and continuing to operation 250 by determining if there is still available area on the motherboard 310.

As seen in FIG. 3B, the highest priority electrochromic device still in the batch after the first electrochromic device 315 was placed is the second electrochromic device 325. As seen in FIG. 3C, the highest priority electrochromic device still in the batch after the first electrochromic device 315 and the second electrochromic device 325 were placed is the third electrochromic device 335. As seen in FIG. 3D, the highest priority electrochromic device still in the batch after the first electrochromic device 315, the second electrochromic device 325, and the third electrochromic device 335 were placed is the fourth electrochromic device 345. While FIGS. 3A-3D show the placement of four electrochromic devices, it can be envisioned that more than four electrochromic devices can be places using the prioritization system described above. In one embodiment, between 1 and 20 electrochromic devices may be placed on a motherboard. The process continues until either the answer at operation 250 or at operation 260 or both is no.

As the process continues, in one embodiment, there will not be enough area on the motherboard 310 to place an additional electrochromic device and the answer will be no. In another embodiment, the yield of the electrochromic device will not be high enough to be placed on the motherboard, even if the motherboard has available area. If no, then the motherboard 310 can be manufactured. In one embodiment, manufacturing the motherboard 310 can include depositing the electrochromic devices on the motherboard 310 as determined by the placement above. In another embodiment, the motherboard 310 can be further processed to separate the one or more electrochromic devices into individual devices and process them as laminate devices or include them within an insulated glazing unit as described below.

FIG. 4 is a schematic illustration of a top view of one or more electrochromic devices on a motherboard, according to another embodiment. In one embodiment, each of the one or more electrochromic devices, 315, 325, 335, and 345 are placed about the center of a side of the motherboard 410.

Any of the electrochemical devices can be subsequently processed as a part of an insulated glass unit. FIG. 5 is a schematic illustration of an insulated glazing unit 500 according the embodiment of the current disclosure. The insulated glass unit 500 can include a first panel 505, an electrochemical device 520 coupled to the first panel 505, a second panel 510, and a spacer 515 between the first panel 505 and second panel 510. The first panel 505 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 505 may or may not be flexible. In a particular embodiment, the first panel 505 can be float glass or a borosilicate glass and have a thickness in a range of 2 mm to 20 mm thick. The first panel 505 can be a heat-treated, heat-strengthened, or tempered panel. In one embodiment, the electrochemical device 520 is coupled to first panel 505. In another embodiment, the electrochemical device 520 is on a substrate 525 and the substrate 525 is coupled to the first panel 505. In one embodiment, a lamination interlayer 530 may be disposed between the first panel 505 and the electrochemical device 520. In one embodiment, the lamination interlayer 530 may be disposed between the first panel 505 and the substrate 525 containing the electrochemical device 520. The electrochemical device 520 may be on a first side 521 of the substrate 525 and the lamination interlayer 530 may be coupled to a second side 522 of the substrate. The first side 521 may be parallel to and opposite from the second side 522.

The second panel 510 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 510 can be float glass or a borosilicate glass and have a thickness in a range of 5 mm to 30 mm thick. The second panel 510 can be a heat-treated, heat-strengthened, or tempered panel. In one embodiment, the spacer 515 can be between the first panel 505 and the second panel 510. In another embodiment, the spacer 515 is between the substrate 525 and the second panel 510. In yet another embodiment, the spacer 515 is between the electrochemical device 520 and the second panel 510.

In another embodiment, the insulated glass unit 500 can further include additional layers. The insulated glass unit 500 can include the first panel, the electrochemical device 520 coupled to the first panel 505, the second panel 510, the spacer 515 between the first panel 505 and second panel 510, a third panel, and a second spacer between the first panel 505 and the second panel 510. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. An apparatus for manufacturing a motherboard comprising one or more electroactive devices, the apparatus comprising: a central processing unit; a memory unit coupled to the central processing unit, wherein the memory comprises instructions executable by the central processing unit, the instructions can include: mapping a motherboard; analyzing the one or more electroactive devices within a batch to determine a yield of each of the one or more electroactive devices; prioritizing the one or more electroactive devices based on the yield; and placing a first electroactive device on the motherboard, wherein the first electroactive device has the highest priority of the one or more electroactive devices within the batch.

Embodiment 2. An apparatus for manufacturing a motherboard including one or more electrochromic devices, the apparatus including: a central processing unit; a memory unit coupled to the central processing unit, where the memory comprises instructions executable by the central processing unit, the instructions including: mapping a motherboard; analyzing one or more electrochromic devices within a batch to determine a yield of each of the one or more electrochromic devices; prioritizing the one or more electrochromic devices based on the yield; and placing a first electrochromic device on the motherboard, where the first electrochromic device has the highest priority of the one or more electrochromic devices within the batch.

Embodiment 3. A method of manufacturing a motherboard including one or more electrochromic devices, the method including: mapping the motherboard; analyzing the one or more electrochromic devices within a batch to determine a yield of each of the one or more electrochromic devices; prioritizing the one or more electrochromic devices based on the yield; and placing a first electrochromic device on the motherboard, where the first electrochromic device has the highest priority of the one or more electrochromic devices within the batch.

Embodiment 4. The apparatus of embodiment 1, where the electroactive device is an electrochromic device.

Embodiment 5. The apparatus or method of any of the preceding embodiments, can further include placing a second electrochromic device on the motherboard, where the second electrochromic device has a lower priority than the first electrochromic device.

Embodiment 6. The apparatus or method of embodiment 5, can further include placing a third electrochromic device on the motherboard, where the third electrochromic device has a lower priority than the second electrochromic device.

Embodiment 7. The apparatus or method of embodiment 6, can further include placing a fourth electrochromic device on the motherboard, where the fourth electrochromic device has a lower priority than the third electrochromic device.

Embodiment 8. The apparatus of either embodiment 1 or 2 or method of embodiment 3, where analyzing the motherboard comprises determining an area of the motherboard.

Embodiment 9. The apparatus or method of embodiment 8, can further include determining whether the area of the motherboard is available or occupied by the one or more electrochromic devices.

Embodiment 10. The apparatus or method of embodiment 9, if it is determined that the motherboard area is available, determining whether the one or more electrochromic devices still in the batch has a high enough yield to be placed on the motherboard.

Embodiment 11. The apparatus or method of embodiment 10, where determining whether the one or more electrochromic devices still in the batch has a yield high enough to be placed on the motherboard comprises comparing the yield of the one or more electrochromic devices in the batch to the yield of the last electrochromic device placed on the motherboard.

Embodiment 12. The apparatus or method of embodiment 11, where comparing the yield of the one or more electrochromic devices in the batch to the yield of the last electrochromic device placed on the motherboard comprises determining if the yield of the one or more electrochromic devices in the batch is within between 1% and 30% of the yield of the last electrochromic placed on the motherboard.

Embodiment 13. The apparatus or method of embodiment 12, where the yield of the one or more electrochromic devices in the batch is within between 2% and 20% of the yield of the last electrochromic placed on the motherboard.

Embodiment 14. The apparatus or method of embodiment 13, where the yield of the one or more electrochromic devices in the batch is within between 5% and 10% of the yield of the last electrochromic placed on the motherboard.

Embodiment 15. The apparatus or method of embodiment 9, if it is determined that the motherboard area is occupied, manufacturing the motherboard with the one or more electrochromic devices placed thereon.

Embodiment 16. The apparatus or method of embodiment 9, if it is determined that the one or more electrochromic devices still in the batch does not have a high enough yield to be placed on the motherboard, manufacturing the motherboard with the one or more electrochromic devices placed thereon.

Embodiment 17. The apparatus of either embodiment 1 or 2 or method of embodiment 3, where determining the yield comprises determining a height to width aspect ratio, determining a scribe orientation, determining a geometric yield, determining a material used for a insulating glazing unit, determining a distance between two or more bus bars on the one or more electrochromic devices, determining a scribe location, determining a resistance, and determining a voltage output necessary to transition the one or more electrochromic devices from a clear state to a tint state.

Embodiment 18. The apparatus of either embodiment 1 or 2 or method of embodiment 3, where each of the one or more electrochromic devices comprises: a substrate; a first transparent conductive layer; a second transparent conductive layer; a cathodic electrochemical layer between the first transparent conductive layer and the second transparent conductive layer; and an anodic electrochemical layer between the first transparent conductive layer and the second transparent conductive layer.

Embodiment 19. The apparatus or method of embodiment 18, where the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, poly butylene terephthalate, poly ether sulfone, poly phenylene sulfide, poly amide, poly amide imide, poly ether imide, poly vinyl chloride, acrylonitrile butadiene styrene, poly ethylene naphthalate, poly propylene, poly ether ether ketone, cyclic olefin copolymer, another suitable transparent polymer, co-polymer of the foregoing, float glass, borosilicate glass, or any combination thereof.

Embodiment 20. The apparatus or method of embodiment 18, where each of the one or more electrochromic devices further comprises an ion conducting layer between the cathodic electrochemical layer and the anodic electrochemical layer.

Embodiment 21. The apparatus or method of embodiment 19, where the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 22. The apparatus or method of embodiment 18, where the cathodic electrochemical layer comprises an electrochromic material.

Embodiment 23. The apparatus or method of embodiment 22, where the electrochromic material comprises WO₃, V₂O₅, MoO₃, Nb₂O₅, TiO₂, CuO, Ni₂O₃, NiO, Ir₂O₃, Cr₂O₃, CO₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 24. The apparatus or method of embodiment 18, where the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 25. The apparatus or method of embodiment 18, where the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

Embodiment 26. The apparatus or method of embodiment 18, where the anodic electrochemical layer comprises a an inorganic metal oxide electrochemically active material, such as WO₃, V₂O₅, MoO₃, Nb₂O₅, TiO₂, CuO, Ir₂O₃, Cr₂O₃, CO₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus for manufacturing a motherboard comprising one or more electroactive devices, the apparatus comprising:
a central processing unit;
a memory unit coupled to the central processing unit, wherein the memory comprises instructions executable by the central processing unit, the instructions comprising:
mapping a motherboard;
analyzing the one or more electroactive devices within a batch to determine a yield of each of the one or more electroactive devices;
prioritizing the one or more electroactive devices based on the yield; and
placing a first electroactive device on the motherboard, wherein the first electroactive device has the highest priority of the one or more electroactive devices within the batch.

2. The apparatus of claim 1, wherein the electroactive device is an electrochromic device.

3. The apparatus of claim 1, wherein analyzing the motherboard comprises determining an area of the motherboard.

4. The apparatus of claim 3, further comprising determining whether the area of the motherboard is available or occupied by the one or more electrochromic devices.

5. The apparatus of claim 4, if it is determined that the motherboard area is available, determining whether the one or more electrochromic devices still in the batch has a high enough yield to be placed on the motherboard.

6. The apparatus of claim 5, wherein determining whether the one or more electrochromic devices still in the batch has a yield high enough to be placed on the motherboard comprises comparing the yield of the one or more electrochromic devices in the batch to the yield of the last electrochromic device placed on the motherboard.

7. The apparatus of claim 6, wherein comparing the yield of the one or more electrochromic devices in the batch to the yield of the last electrochromic device placed on the motherboard comprises determining if the yield of the one or more electrochromic devices in the batch is within between 1% and 30% of the yield of the last electrochromic placed on the motherboard.

8. The apparatus of claim 7, wherein the yield of the one or more electrochromic devices in the batch is within between 2% and 20% of the yield of the last electrochromic placed on the motherboard.

9. The apparatus of claim 8, wherein the yield of the one or more electrochromic devices in the batch is within between 5% and 10% of the yield of the last electrochromic placed on the motherboard.

10. The apparatus of claim 9, if it is determined that the motherboard area is occupied, manufacturing the motherboard with the one or more electrochromic devices placed thereon.

11. The apparatus of claim 9, if it is determined that the one or more electrochromic devices still in the batch does not have a high enough yield to be placed on the motherboard, manufacturing the motherboard with the one or more electrochromic devices placed thereon.

12. The apparatus of claim 1, wherein each of the one or more electrochromic devices comprises:
a substrate;
a first transparent conductive layer;
a second transparent conductive layer;
a cathodic electrochemical layer between the first transparent conductive layer and the second transparent conductive layer; and
an anodic electrochemical layer between the first transparent conductive layer and the second transparent conductive layer.

13. The apparatus of claim 12, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

14. The apparatus of claim 12, wherein each of the one or more electrochromic devices further comprises an ion conducting layer between the cathodic electrochemical layer and the anodic electrochemical layer.

15. An apparatus for manufacturing a motherboard comprising one or more electrochromic devices, the apparatus comprising:
a central processing unit;
a memory unit coupled to the central processing unit, wherein the memory comprises instructions executable by the central processing unit, the instructions comprising:
mapping a motherboard;
analyzing one or more electrochromic devices within a batch to determine a yield of each of the one or more electrochromic devices;
prioritizing the one or more electrochromic devices based on the yield; and
placing a first electrochromic device on the motherboard, wherein the first electrochromic device has the highest priority of the one or more electrochromic devices within the batch.

16. A method of manufacturing a motherboard comprising one or more electrochromic devices, the method comprising:
mapping the motherboard;
analyzing the one or more electrochromic devices within a batch to determine a yield of each of the one or more electrochromic devices;
prioritizing the one or more electrochromic devices based on the yield; and
placing a first electrochromic device on the motherboard, wherein the first electrochromic device has the highest priority of the one or more electrochromic devices within the batch.

17. The method of claim 16, further comprising placing a second electrochromic device on the motherboard, wherein the second electrochromic device has a lower priority than the first electrochromic device.

18. The method of claim 17, further comprising placing a third electrochromic device on the motherboard, wherein the third electrochromic device has a lower priority than the second electrochromic device.

19. The method of claim 18, further comprising placing a fourth electrochromic device on the motherboard, wherein the fourth electrochromic device has a lower priority than the third electrochromic device.

20. The method of claim 16, wherein determining the yield comprises determining a height to width aspect ratio, determining a scribe orientation, determining a geometric yield, determining a material used for a insulating glazing unit, determining a distance between two or more bus bars on the one or more electrochromic devices, determining a scribe location, determining a resistance, and determining a voltage output necessary to transition the one or more electrochromic devices from a clear state to a tint state.
